(19) United States
(12) Patent Application Publication
(10) Pub. No.: US 2011/0107671 A1
(43) Pub. Date: May 12, 2011

(54) SYSTEM AND OPERATOR FOR DOOR

(76) Inventor: Michael B. Lloyd, Florence, KY (US)

(21) Appl. No.: 12/830,982

(22) Filed: Jul. 6, 2010

Related U.S. Application Data
(60) Provisional application No. 61/223,102, filed on Jul. 6, 2009.

(51) Int. Cl. E05F 15/06; F25D 23/02

(52) U.S. Cl. 49/32; 49/358

(57) ABSTRACT

A system for moving a door between open and closed positions to selectively allow access to an enclosed space. The system comprising a door, the door being slidably movable between a first closed position and a second open position, the door being operative to close an opening to an enclosed space, an actuator operative to initiate movement of the door from its first closed position toward its second open position, and a control unit, the control unit including a motor, the control unit being responsive to initial movement of the door and being operative to actuate the motor, the motor being selectively operative to slidingly move the door toward the open position in response to the initial door movement after the door has initially moved from its closed position

### RELATED APPLICATIONS

This application claims priority under 35 U.S.C. §119(e) to U.S. Provisional Application Ser. No. 61/223,102, filed Jul. 6, 2009.

### FIELD OF THE INVENTION

The invention relates generally to electric door systems and operators for the same and more particularly to a sliding door system and an operator for moving doors. In one preferred embodiment, the sliding door system includes an operator that requires an individual to assist in the initial movement of a door of a commercial cooler/freezer.

### BACKGROUND OF THE INVENTION

Conventionally, heavily insulated doors, such as for walk-in cooler/freezer, have often used swinging doors that need to be manually opened and closed. However, manual operation of freezer or cooler doors can be quite inconvenient and burdensome, especially when the doors are heavily insulated and weighty and are opened frequently. In addition, swinging doors can also be hazardous to individuals in close proximity to the doors. Specifically, individuals opening the doors as they enter or exit the freezer or cooler unit can strike others in close proximity with the door and cause serious physical harm to the person.

Sliding doors for walk-in freezer or cooler units are well known in the industry. Manually operated doors have the advantage of being relatively inexpensive, but frequently are difficult and inconvenient to open and shut. As a consequence, it is not uncommon for workers to leave the door in the open position for extended periods of time, particularly when the worker intends to make repeated trips into and out of the cooler/freezer. Leaving the door open, of course, results in substantial energy loss, and economic waste. It also is known to use sliding doors that are motor-driven. Unfortunately, due to the weight of the doors and the especially the energy required to initially move the doors from their sealing position, relatively large electrical motors are required to open the doors. What has been needed in the industry, but has not been available, is an inexpensive door system that is easily and inexpensively installed, that opens easily and closes when it is desired to close the door.

Many of the designs that have been proposed have proven unreliable and costly, due to their highly complex designs. In addition, such prior designs have also been found to be difficult to install and difficult to service and maintain by maintenance personnel.

As such, there remains a need for an system for an electric door that includes an operator which can be installed with existing low power electrical service and which overcomes the unreliability, costs and difficulties noted above and provides a simple, straightforward and inexpensive system for sliding doors.

### SUMMARY OF THE INVENTION

In one embodiment of the invention, a system for moving a door between open and closed positions to selectively allow access to an enclosed space. The system comprising a door, the door being slidably movable between a first closed position and a second open position, the door being operative to close an opening to an enclosed space, an actuator operative to initiate movement of the door from its first closed position toward its second open position, and a control unit, the control unit including a motor, the control unit being responsive to initial movement of the door and being operative to actuate the motor, the motor being selectively operative to slidingly move the door toward the open position in response to the initial door movement after the door has initially moved from its closed position.

In yet another embodiment of the invention, an operator for moving a door between open and closed positions to selectively allow access to an enclosed space. The operator comprises an actuator operative to initiate door movement from its first closed position toward its second open position and a control unit, the control unit including a motor, the control unit being responsive to initial door movement and being operative to actuate the motor, the motor being selectively operative to slidingly move the door toward the open position in response to the initial door movement after the door has initially moved from its closed position.

### BRIEF DESCRIPTION OF THE DRAWINGS

While the invention concludes with claims which particularly point out and distinctly claim the invention, it is believed the present invention will be better understood from the following description taken in conjunction with the accompanying drawings, in which like reference numbers identify the same elements in which:

FIG. 1 is a perspective view of the system and operator for moving a door constructed in accordance with the principles of the present invention;

FIG. 2 is another perspective view of the system and operator for moving a door constructed in accordance with the principles of the present invention;

Reference will now be made in detail to certain exemplary embodiments of the invention, examples of which are illustrated in the accompanying drawings.

### DETAILED DESCRIPTION

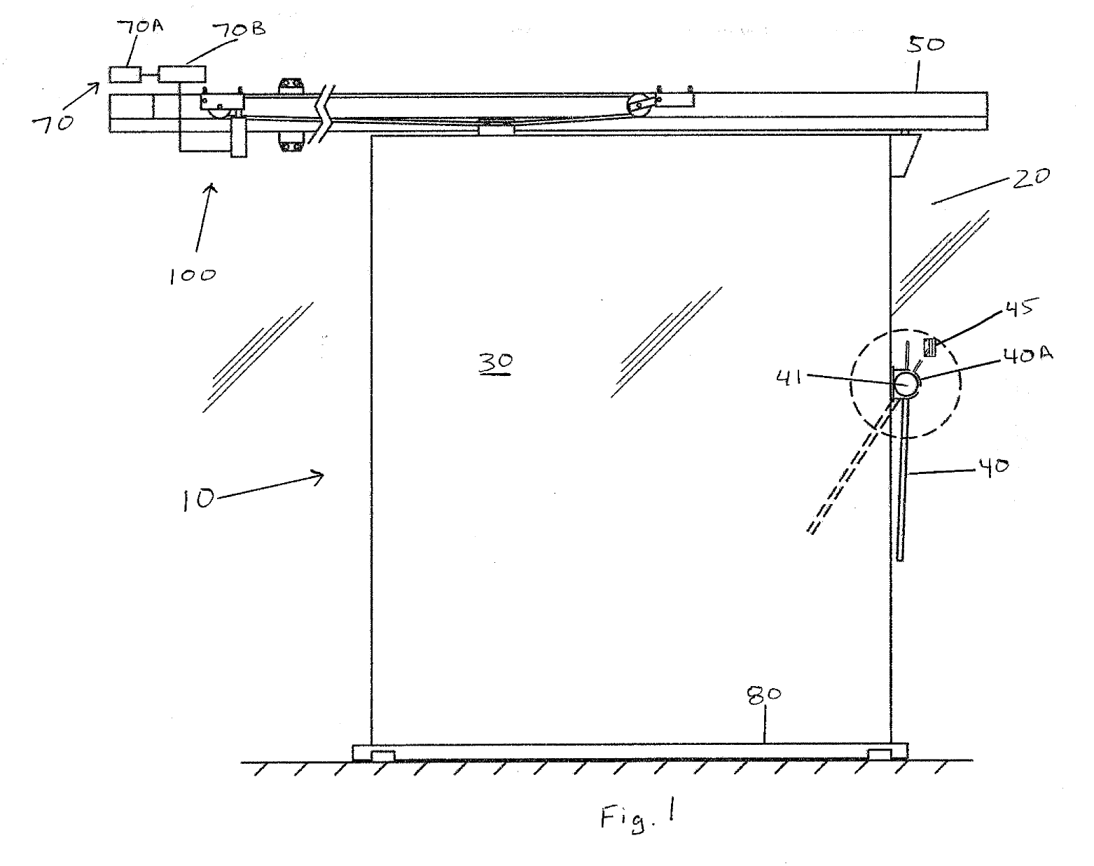

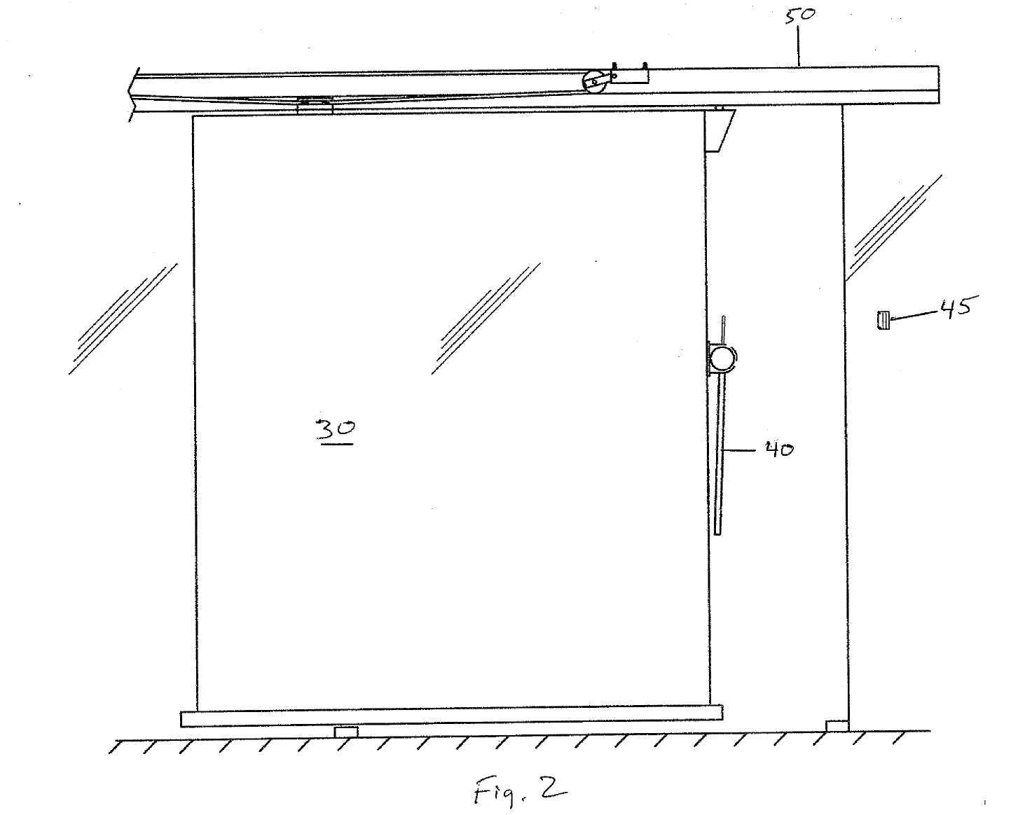

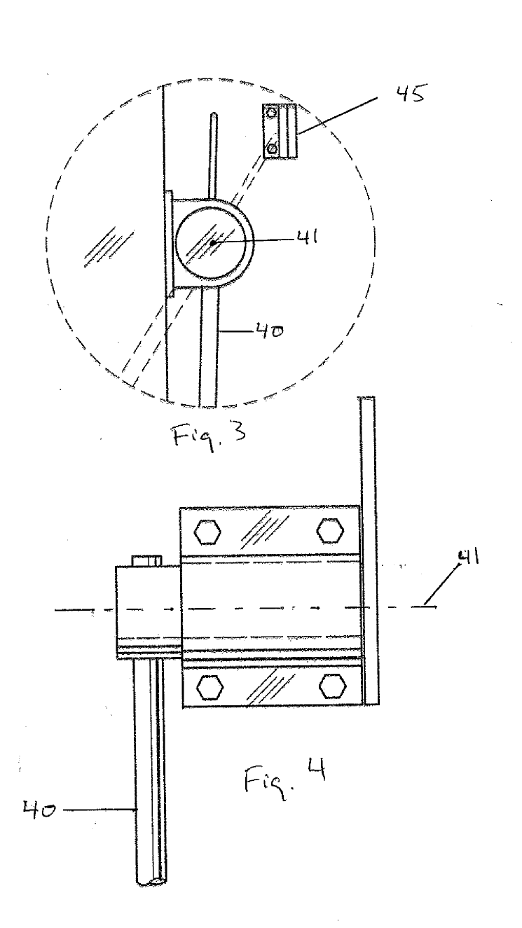

Referring now to the drawings, FIGS. 1 and 2 show a perspective view of one embodiment of an electric door system and operator, generally designated in the drawings by the numerals 10 and 100, respectively, and constructed in accordance with the principles of the present invention. The electric door system 10 includes a door frame 20 and door 30. Typically both the door frame 20 and door 30 may be constructed of stainless steel, plastic, a combination of both materials or some other resilient material or materials and are constructed for an individual, material or equipment to pass through. However, it will be understood that both the door frame 20 and door 30 may be constructed of any material or in any size or shape, as known in the art. It will be further understood that the door frame 20 is configured for placement between an interior or enclosed space and an exterior. In one embodiment, the interior or enclosed space may be a walk-in freezer or a cooler. In yet other embodiments, the door 20 may be a freezer door or cooler door.

In the exemplarily embodiments illustrated in FIGS. 1 and 2, the electric door system 10 may further include an actuator 40, illustrated in the present FIGS. 1 and 2 as a rotatable handle bar 40 that manually assists movement of the door 20. However, it will be understood that although illustrated in the present FIGS. 1 and 2 as a rotatable handle bar that manually assists movement of the door 20, the actuator 40 may be any device that assists in any movement of the door 20 as known in the art. The handle bar 40, as shown in the embodiments illustrated in FIGS. 1 and 2, rotates a pivot in a sleeve 40A about an axis 41. The sleeve 40A and its internal pivot include a radially projecting kick-off lever 40B that is configured to interact with a pry plate 45 secured on the frame adjacent to the edge of the door 30. With this configuration or leverage system, a manually applied rotational force applied against the end of the handle 40 will apply a force against the pry plate 45, and urge the door toward its open position. It will be further understood that the purpose of the handle is to provide a mechanical advantage for a manual force applied against the end of the handle, and for this reason, the length of the handle 40 may be relatively long as compared to the radially projecting lever. By using the mechanical advantage of the relatively long handle 40, a moderate manual force applied against the handle 40 acts to apply a multiplied force against the pry plate 45. This multiplied force is used to move the door in an upward, outward direction to unseal the door, and start movement of the door 30 along the track 50, as explained in greater detail below. As those skilled in the art will appreciate, other types of handles also might be used, as for example, a grab handle, a pull handle, or a recessed handle, or alternatively, the initial movement of the door could be effected without a handle.

In the exemplary embodiments illustrated in FIGS. 1 and 2 the system 10 may also include a track 50 for directing sliding movement of the door 30. The track 50, as shown in the embodiments illustrated in FIGS. 1 and 2, is positioned above the access opening to the cooler/freezer, and for a length that spans the opening. It may be mounted, at least in part, to the door frame 20. A roller system attached to the door 30 roll in the track 50, and the track 50 functions to guide movement of the roller system, and hence control the sliding path of the door 3. Typically the track 50 may be constructed of steel, aluminum, plastic, a combination of these materials. In one specific embodiment, the track 50 may be configured for the door 30 to move from a closed position to an open position. In particular, the “closed position,” as that term is used throughout the present disclosure is when the door 30 prevents or otherwise restricts access to the interior space. Furthermore, the “open position,” as that term is used throughout the present disclosure is when the door 30 allows or otherwise does not restrict access to the interior space.

Referring now to the embodiments illustrated in FIGS. 1 and 2, the system 10 and operator 100 includes a control unit 70 with an associated motor 70A and an encoder 70B. As specifically illustrated, the encoder 70B senses rotational movement of the motor (which corresponds to movement of the door), and generates a signal that the control unit 70 recognizes, and in turn, activates the motor 70A, whenever the door 30 is moved a predetermined distance. As is known in the art, the track 50 may include detents to direct the door 30 in a downward and inward direction as the door approaches its closed position. When such a configuration is used, opening the door 30 from its closed, sealed position requires sufficient energy to lift the door upwardly to initiate movement toward the open position. After this initial movement, however, substantially less energy is required to move the door 30 toward the open position. Consequently, when the motor 70A is used in conjunction with door movement, described above, the motor 70A requires sufficient power only to move the door for the remainder of the opening movement and for the closing movement. In other words, the initial opening movement can be effectuated by a manual activator, such as the handle mechanism 40, and the remainder of the movement can be achieved with a motor 70A that is much smaller, lighter duty, and less expensive, than a motor used for moving the door 30 throughout its entire range of movement, including the initial opening movement. Furthermore, the lighter duty motor does not require expensive, heavy-duty control components needed for heavy duty motors. Hence, the encoder 70B shown at the bottom of the motor 70A, or another type of sensor unit for detecting the initial displacement of the door 30, can be used to initiate the motor only after the initial opening displacement is detected. In one specific embodiment, the control unit 70 is configured to generate a movement signal only after detecting motion of the door 30 past a predetermined span along the length of the track 50.

In the exemplary embodiments illustrated in FIG. 1 the system 10 may also include a guide rail 80, which guides the bottom portion of the door 30 as the door slides from between its closed and open positions.

The door 30 of a cooler/freezer normally is kept in its closed position in order to avoid excessive loss of energy. In use, an individual wishing to gain access to the interior space of the cooler/freezer initially grasps and rotates the handle 40. This manual movement of the handle 40 applies a force against the pry plate 45. This force results in an initial movement of the door 30 that move the rollers out of the detents in the track 50, unsealing the door 30 and moving it upwardly and outwardly toward the open position. After this initial opening displacement, the control unit 70 senses the displacement of the door 30 through use of the encoder 70B and activates the motor 70A. Once activated, the motor 70A completes movement of the door 30 to the open position without any further force needed by the individual and thereafter holds the door 30 in the open position. Closing of the door 30 can be initiated after an number of selected events. For example, the control 70 could be programmed to close the door 30 after a predetermined amount of time. Alternatively, or in addition, the system could be programmed to reverse direction of the motor 70A and close the door 30 upon the displacement of the door 30 toward the closed position. In either event, the motor 70A would cease complete displacement of the door 30 at its closed and sealed position.

Advantageously, the electric door system and operators illustrated in the exemplary embodiments of FIGS. 1-2 allow for, inter alia, a simple and low cost way to open a sliding door, and alleviate the need for a high powered electric motor and the control components necessary to operate it. That is, the electric door system and operators developed in accord with the principles described herein help eliminate the difficulties noted above and provides a simple, straightforward and less arduous system for sliding doors.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed is:

1. A system for moving a door between open and closed positions to selectively allow access to an enclosed space, comprising:
a door, the door being slidably movable between a first closed position and a second open position, the door being operative to close an opening to an enclosed space;
an actuator operative to initiate movement of the door from its first closed position toward its second open position; and
a control unit, the control unit including a motor, the control unit being responsive to initial movement of the door and being operative to actuate the motor, the motor being selectively operative to slidingly move the door toward the open position in response to the initial door movement after the door has initially moved from its closed position.

2. A system as recited in claim 1 wherein the actuator is a manual actuator.

3. A system as recited in claim 1 further including a door frame defining the opening to the enclosed space.

4. A system as recited in claim 3 wherein the actuator includes a leverage system for separating the door from the door frame to initiate movement of the door from the closed to open positions.

5. A system as recited in claim 4 wherein the actuator is a manual actuator that is mounted on the door, and the leverage system applies a force between the door and the door frame to initiate movement of the door from the closed to open positions.

6. A system as recited in claim 5 further including a pry plate mounted on the door frame, the leverage system being selectively engagable with the pry plate to push the door and slidingly separate the door away from the door frame.

7. A system as recited in claim 4 wherein the control unit further including a sensor unit for detecting movement of the door relative to the door frame, and wherein the sensor unit is operative to actuate the motor.

8. A system as recited in claim 7 wherein the sensor unit includes an encoder for detecting movement of the door.

9. A system as recited in claim 8 wherein the encoder generates the motion detection signal only when detecting motion of the door past a predetermined distance.

10. A system as recited in claim 1 wherein the motor is further operative to move the door from the open position to the closed position.

11. A system as recited in claim 1 wherein the closed position is a sealed position and the actuator is further operative to initiate movement of the door from its sealed position toward its open position.

12. A system as recited in claim 1 furthering comprising a track for directing sliding movement of the door from the closed to the open position.

13. A system as recited in claim 12 wherein the track includes a dent and the door is operative to move upwardly and outwardly out of the dent to move from the closed to the open position.

14. A system as recited in claim 12 wherein the enclosed space is a cooler or freezer.

15. An operator for moving a door between open and closed positions to selectively allow access to an enclosed space, comprising:
an actuator operative to initiate door movement from its first closed position toward its second open position; and
a control unit, the control unit including a motor, the control unit being responsive to initial door movement and being operative to actuate the motor, the motor being selectively operative to slidingly move the door toward the open position in response to the initial door movement after the door has initially moved from its closed position.

16. An operator as recited in claim 15 wherein the actuator is a manual actuator.

17. An operator as recited in claim 15 wherein the control unit further including a sensor unit for detecting movement of the door relative to a door frame, and wherein the sensor unit is operative to actuate the motor.

18. An operator as recited in claim 17 wherein the sensor unit includes an encoder for detecting movement of the door.

19. An operator as recited in claim 18 wherein the encoder generates the motion detection signal only when detecting motion of the door past a predetermined distance.

20. A system as recited in claim 15 wherein the motor is further operative to move the door from the open position to the closed position.
